(19) United States
(12) Patent Application Publication
(10) Pub. No.: US 2015/0358076 A1
(43) Pub. Date: Dec. 10, 2015

(54) PORT-DUALIZED OPTICAL LINE TERMINAL AND PASSIVE OPTICAL NETWORK SYSTEM CAPABLE OF MEASURING RSSI OF STANDBY LINE IN STANDBY PORT, AND METHOD OF DETERMINING STABILITY OF STANDBY LINE USING THE SAME

(71) Applicant: UBIQUOSS Inc., Gyeonggi-do (KR)

(72) Inventors: Young Seok Yang, Seoul (KR); Shin Hak Yang, Gyeonggi-do (KR)

(21) Appl. No.: 14/734,616

(22) Filed: Jun. 9, 2015

(30) Foreign Application Priority Data
Jun. 9, 2014 (KR) 1020140069266

(51) Int. Cl. H04B 10/079

(52) U.S. Cl. CPC H04B 10/0791; H04B 10/07955

(57) ABSTRACT

Disclosed herein are a port-dualized Optical Line Terminal (OLT) and PON system, and a method of determining the stability of a standby line. The OLT includes an active Passive Optical Network (PON) port for measuring active RSSI values of a first optical module in response to a signal from a PON Media Access Control (MAC) chip, a standby PON port for allowing a second optical module to autonomously measure and store standby RSSI values, and a Central Processing Unit (CPU) for activating the active PON port, setting the standby PON port in preparation for occurrence of an event in the active PON port, and determining the active RSSI values and the standby RSSI values, based on a comparison therebetween. Accordingly, the stability of the standby trunk line may be predetermined in advance.

### BACKGROUND OF THE INVENTION

1. Field of the Invention

The present invention generally relates to a port-dualized Optical Line Terminal (OLT) and a port-dualized Passive Optical Network (PON) system, which are capable of measuring the Received Signal Strength Indicator (RSSI) of a standby line in a standby PON port, and a method of determining the stability of a standby line using the OLT and the PON system. More particularly, the present invention relates to a port-dualized OLT and a port-dualized PON system, which sample in real time the RSSI values measured in a standby line before a fault occurs in an active line, and take preemptive action so that, even if a current line switches from the active line to the standby line upon protection switching due to the fault occurring in the active line, the RSSI value of the standby line is maintained in an allowable range of the RSSI value of the active line.

Further, the present invention relates to a port-dualized OLT and port-dualized PON system capable of measuring RSSI even in a standby port, which can determine the stability of a standby line before protection switching in order to prevent a service from continuously interrupting due to an event such as the disconnection of an optical fiber in the standby line that is waiting even if protection switching is operated when an event occurs, in a port-dualized PON system in which the trunk lines of an OLT and a plurality of ONTs are dualized into active lines and standby lines and in which, when an event occurs in an active line in use, traffic is switched from an active PON port to a standby PON port under the control of a Central Processing Unit (CPU).

Furthermore, the present invention relates to a port-dualized OLT and port-dualized PON system capable of measuring RSSI in a standby port, which are configured such that, even if an event such as the disconnection of an optical fiber in a standby line has been recovered, when recovery is incomplete, an RSSI value is still measured and compared with the RSSI value of an active line, and then the standby line can be determined to be instable if the degree of attenuation of the RSSI of the standby line falls out of an allowable range and then increases.

2. Description of the Related Art

Generally, a Passive Optical Network (PON) is configured such that a passive device is provided in a Remote Node (RN), and a service provider and a plurality of Optical Network Terminals (ONTs)(or Optical Network Units: ONUs) are connected to each other in a single section. Since such a PON uses a passive optical device, there is no need to separately manage the optical device and to supply power to the optical device.

Such a PON employs a scheme for providing a high-speed communication service to subscribers using an optical fiber, wherein a single OLT functioning as a center office is connected to N ONTs or ONUs via the RN. In such a PON, 32 or 64 ONUs near subscribers are typically installed on a single OLT located in a center office.

In this case, when a communication failure occurs due to an event such as a fault in the OLT or the disconnection of an optical fiber between the OLT and the RN, all ONUs are disconnected, thus preventing all subscribers from being provided with a communication service due to the communication failure.

In order to solve this problem, the dualization of an OLT (or a port) has been presented in a PON. That is, a PON system supporting dualization prepares an additional standby OLT/standby line in addition to an active OLT/active line. Accordingly, if a fault occurs in the active OLT/active line, the standby OLT/standby line that is waiting replaces the faulty active OLT/active line.

However, unexpected other problems may arise in spite of dualization in the dualization-supporting PON system.

When a standby line is disconnected due to the carelessness of a worker during excavation work, it is typically, roughly reconnected in many cases because the standby line is not a main line that is immediately and currently used. Accordingly, even if a fault actually occurs in an active line and line switching to the standby line is activated, the roughly-connected standby line does not sufficiently exhibit its own function, thus deteriorating switching effect.

Such a standby line disconnection event occurs several tens of times or more per day, which results in unexpected service interruption in spite of dualization switching.

In this way, according to the conventional dualization-supporting PON system, the OLT cannot determine the status of a standby line.

More specifically, even if a fault occurs in an active OLT/active line and line switching is performed, when line switching to a standby line, the attenuation degree of which is not known, is conducted, the degree of light attenuation increases to a reference level or more, thus making switching to the standby line useless. In this way, switching to an abnormal standby line results in a secondary problem due to the standby line itself, thus causing unexpected service interruption, which is more serious than a primary problem.

Consequently, since an OLT does not operate an RSSI measurement function for a standby line due to the structure of a current PON system, a problem arises in that a fault in the standby line cannot be determined.

### PRIOR ART DOCUMENTS

### Patent Documents

(Patent Document 1) KR 2014-0031648

### SUMMARY OF THE INVENTION

Accordingly, the present invention has been made keeping in mind the above problems occurring in the prior art, and an object of the present invention is to provide a port-dualized OLT and a port-dualized PON system, which can measure RSSI in a standby PON port and then determine the stability of a standby line.

Another object of the present invention is to provide a port-dualized OLT and a port-dualized PON system, which allow the reception optical module of a standby PON port to autonomously measure and store RSSI values.

A further object of the present invention is to provide a port-dualized OLT and a port-dualized PON system, which allow an OLT to determine the RSSI values of an active optical module and a standby optical module, based on a comparison therebetween.

In order to accomplish the above objects, the present invention provides a port-dualized Passive Optical Network (PON) system, the system being configured such that trunk lines of an Optical Line Terminal (OLT) and a plurality of Optical Network Terminals (ONTs) are dualized into active lines and standby lines, and such that, when a fault occurs in an active line in use, protection switching of traffic from an active PON port to a standby PON port is performed under control of a Central Processing Unit (CPU), wherein the active PON port includes a first optical module for transmitting/receiving an optical signal to/from each ONT through the active line, and a PON Media Access Control (MAC) chip for applying a trigger signal to the first optical module and then detecting a loss-of-signal (LOS) signal, and the standby PON port comprises a second optical module for transmitting/receiving an optical signal to/from the ONT through the standby line, and autonomously detecting a LOS signal in response to a self-trigger signal in compliance with an operation command from the CPU.

Further, the present invention provides a port-dualized Optical Line Terminal (OLT), including an active Passive Optical Network (PON) port for measuring active RSSI values of a first optical module in response to a signal from a PON Media Access Control (MAC) chip, a standby PON port for allowing a second optical module to autonomously measure and store standby RSSI values, and a Central Processing Unit (CPU) for activating the active PON port, setting the standby PON port in preparation for occurrence of an event in the active PON port, and determining the active RSSI values and the standby RSSI values, based on a comparison therebetween.

In addition, the present invention provides a method of determining stability of a standby line using a port-dualized PON system, including allowing an optical module of a standby PON port to autonomously measure RSSI values of a standby line in response to a self-trigger signal in compliance with an operation command from a CPU, storing the standby RSSI values in the optical module, reading, by the CPU, the stored standby RSSI values, and comparing the standby RSSI values with active RSSI values detected by an active PON port, and determining, by the CPU, the standby line to be instable if, as a result of the comparison, a degree of attenuation of the standby RSSI values increases above a reference degree.

### BRIEF DESCRIPTION OF THE DRAWINGS

FIG. 1 is a configuration diagram showing a port-dualized optical network system in which a standby PON port is capable of measuring the RSSI value of a standby line according to the present invention;

FIG. 2 is a block diagram of an optical module for monitoring an RSSI value via self-operation without requiring an external input from a PON MAC chip according to the present invention;

FIG. 3 is a diagram illustrating an example of storage location where RSSI values are stored in a predetermined area of an optical module according to the present invention;

FIG. 4 is a diagram showing an example of a storage sequence in which RSSI values are stored regardless of sequence according to the present invention;

FIG. 5A is a configuration diagram showing normal status obtained as a result of measuring an RSSI value so as to determine the stability of a standby line according to the present invention;

FIG. 5B is a configuration diagram showing faulty status in which an optical fiber is disconnected and needs to be recovered, as a result of measuring an RSSI value so as to determine the stability of the standby line according to the present invention; and

FIG. 5C is a configuration diagram showing faulty status in which, as a result of measuring an RSSI value so as to determine the stability of the standby line, the degree of optical attenuation increases to a level falling out of an allowable range compared to the RSSI value of an active line and then an additional recovery is required in spite of fault recovery, according to the present invention.

### DESCRIPTION OF THE PREFERRED EMBODIMENTS

The features and advantages of the present invention and methods for achieving them will be more clearly understood from the following detailed description of embodiments taken in conjunction with the accompanying drawings. However, the present invention may be implemented in various forms without being limited by the following embodiments. The present embodiments are intended to make the disclosure of the present invention complete and to completely notify those skilled in the art of the scope of the invention. Further, the present invention is merely defined by the scope of the accompanying claims. The sizes and relative sizes of layers and areas in the drawings may be exaggerated to make the description clearer. Throughout the different drawings, the same reference numerals are used to designate the same or similar components.

The embodiments of the present specification will be described with reference to ideal schematic diagrams and sectional views of the present invention. The form of exemplary diagrams may be changed depending on manufacturing technology and/or allowable errors. Accordingly, the embodiments of the present invention are not limited to illustrated specific forms and may include variations in forms generated according to the manufacturing process. Therefore, areas illustrated in the drawings have schematic attributes and the shapes thereof are intended to illustrate the specific shapes of areas of devices and are not intended to limit the scope of the present invention.

Hereinafter, preferred embodiments of a port-dualized OLT and PON system capable of measuring the RSSI of a standby line according to the present invention will be described in detail with reference to the attached drawings.

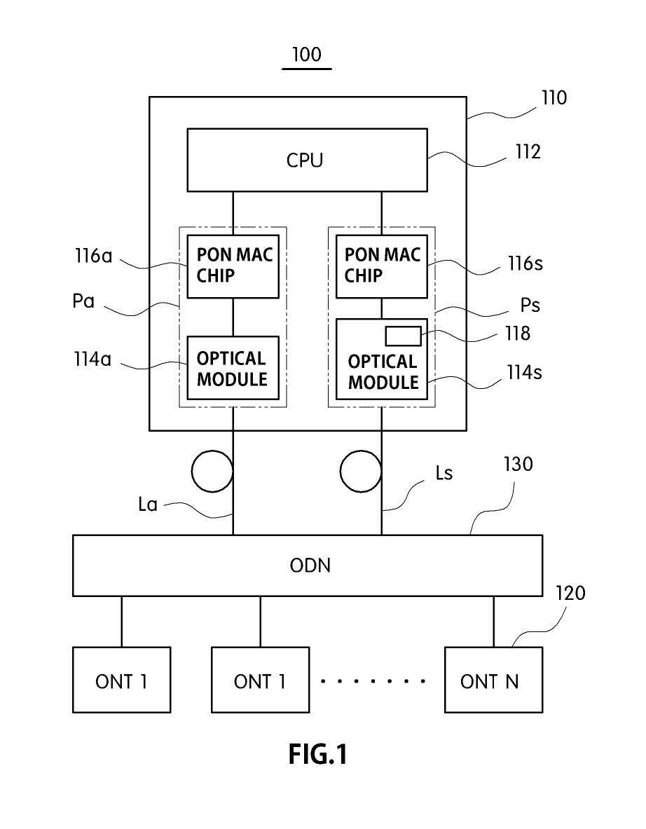

As shown in FIG. 1, a dualization-supporting PON system 100 according to the present invention includes a single Optical Line Terminal (or termination) (OLT) 110 corresponding to an upper-level system, a plurality of Optical Network Terminals (ONTs) (or Optical Network Units: ONUs) 120 corresponding to a lower-level system, and an Optical Distribution Network (ODN) 130 for allowing the single OLT 110 to be connected to the plurality of ONTs 120.

The dualization-supporting PON system 100 has a structure in which a passive distributor or a wavelength-division multiplexing device is used between a network terminal and a subscriber access node, such as a Fiber To The Home (FTTH) network or a Fiber To The Curb (FITC) network, wherein the node may configure a bus or tree structure network. The dualization-supporting PON system 100 according to the present invention may have the form of an Asynchronous Transfer Mode: ATM) PON (APON), an Ethernet PON (EPON), or a Gigabit PON (GPON).

The dualization-supporting PON system 100 according to the present invention may include a port-dualized system in the single OLT 110, and a line-dualized system accompanied with the port-dualized system. For example, in each of the ODN 130 and the OLT 110, PON ports are dualized. On the dualized PON ports Pa and Ps, an active line La and a standby line Ls are respectively formed. Accordingly, when a fault occurs in the active PON port Pa or the active line La in use, it is switched to the standby PON port Ps or the standby line Ls, thus preventing service interruption from occurring.

Therefore, the OLT 110 may include at least one pair of an active PON port Pa and a standby PON port Ps, and a Central Processing Unit (CPU) 112 for switching a current port from the active PON port Pa to the standby PON port Ps when a communication failure is detected.

The active PON port Pa includes an optical module 114a for providing an optical signal to the downlink active line La or detecting an optical signal from the uplink active line La, and a PON Media Access Control (MAC) chip 116a for processing a PON protocol, thus enabling the PON MAC chip 116a to control the optical module 114a through an Input/Output (I/O) channel.

Similarly, the standby PON port Pa includes an optical module 114s for providing an optical signal to the downlink standby line Ls or detecting an optical signal from the uplink active line La, and a PON MAC chip 116s for processing a PON protocol.

In this case, the CPU 112 is mounted on a main board, and the ports Pa and Ps may be mounted in line cards, respectively. Each of the optical modules 114a and 114s may include a 1-Gigabit Small Form-factor Pluggable (SFP) module or a 10-Gigabit Small Form-Factor Pluggable (XFP) module.

Since the active PON port Pa and the standby PON port Ps are connected to the ODN 130 through the separate lines La and Ls, the ODN 130 includes a 2:N optical splitter for performing optical distribution between the dualized PON ports Pa and Ps and the plurality of ONTs 120. That is, the dualization-supporting PON system 100 according to the present invention configures the splitter of the ODN 130 used in a PON section in a 2:N form, and thus the optical link port of the OLT 110 may be divided into the active PON port Pa and the standby PON port Ps.

Therefore, in each of the OLT 110 and the ODN 130, an optical link port is individually dualized. Trunk lines are dualized, and the active line La and the standby line Ls correspond to the dualized PON ports Pa and Ps, respectively. Accordingly, when a fault occurs in the active PON port Pa and the active line La which are in use, they are switched to the standby PON port Ps and the standby line Ls, and the loss of data is minimized.

The CPU 112 sets the active PON port Pa, which is normally operated, and the standby PON port Ps, which is reserved to prepare for the occurrence of an event, in the pair of PON ports Pa and Ps, and determines whether to switch the port from the active PON port Pa to the standby PON port Ps when a fault is detected. Therefore, the active PON port Pa and the standby PON port Ps may be selectively activated under the control of the CPU 112.

When a fault occurs in the active PON port Pa in operation and then the active PON port Pa is switched to the standby PON port Ps that is waiting, if the recovery of the fault in the active PON port Pa has been completed, the active PON port Pa is set to the standby PON port Ps and the standby PON port Ps is set to the active PON port Pa, and then the active PON port Pa and the standby PON port Ps are relative to each other.

Since the present invention is characterized in that even the standby PON port Ps enables RSSI measurement so as to determine the stability of the standby line Ls, as described above, the standby PON port Ps further includes an RSSI measurement and storage module 118. The RSSI measurement and storage module 118 may be either provided in the optical module 114s or provided separately from the optical module 114s.

Therefore, the present invention is characterized in that a function of measuring RSSI values in the standby PON port Ps, as well as in the active PON port Pa, is performed. That is, the standby PON port Ps itself may autonomously monitor the RSSI values of the standby line Ls at regular intervals via the RSSI measurement function.

However, methods of measuring and storing RSSI values are different from each other between the active PON port Pa and the standby PON port Ps.

For example, the active PON port Pa may monitor the RSSI values of the active line La by operating an RSSI trigger in compliance with the command of the CPU 112, whereas the standby PON port Ps may be autonomously operated without an external input, and may measure the RSSI values of the standby line Ls using its own trigger operation.

In the active PON port Pa, when a trigger signal is applied from the PON MAC chip 116a to the optical module 114a, a loss-of-signal (LOS) signal may be generated in the optical module 114a and detected by the PON MAC chip 116a, and may be used to determine whether a fault has occurred.

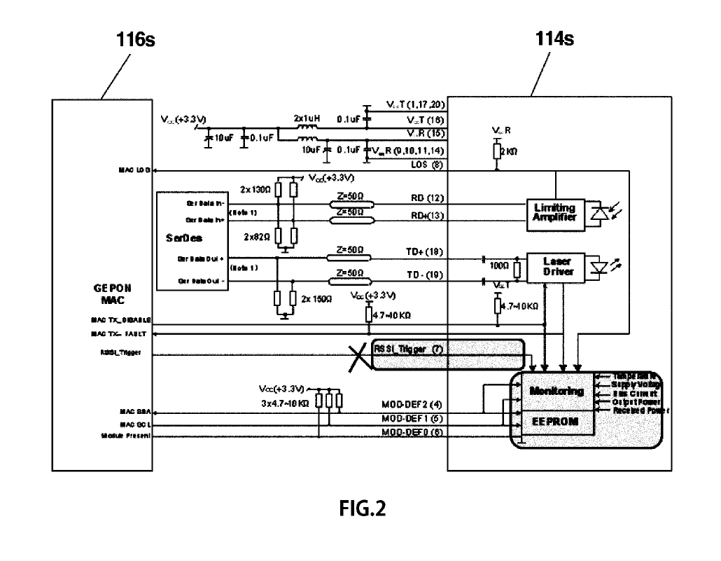

In contrast, in the standby PON port Ps, when an operation command is received from the CPU 112, the RSSI values of the standby line Ls are monitored, wherein a trigger signal is not applied by the PON MAC chip 116s and the optical module 114s autonomously measures RSSI values in response to a self-trigger signal. For example, as shown in FIG. 2, the optical module 114s is self-operating without an external input at the corresponding pin (portion “X” in the drawing) and then monitors RSSI values.

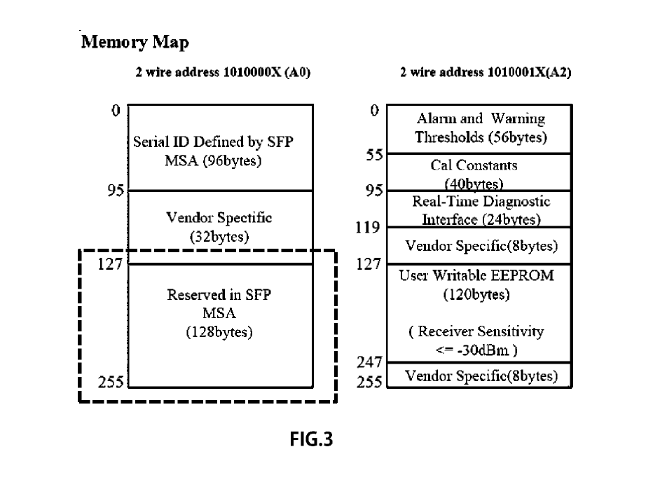

Further, as shown in FIG. 3, the LOS signal generated in response to the self-trigger signal may be stored in a predetermined storage space or the RSSI measurement and storage module 118 without being provided to the PON MAC chip 116s, or may function to provide an alarm to the CPU 112. For example, measured RSSI values may be stored in an undefined area (designated by addresses 127 to 255). The CPU 112 may read and use the measured RSSI values stored in the corresponding area if necessary.

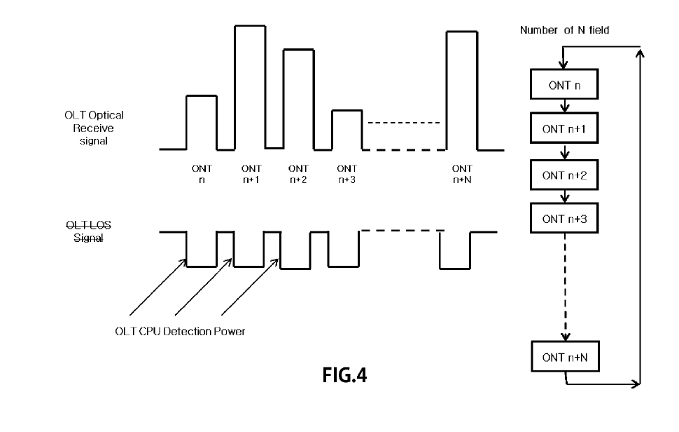

Further, as shown in FIG. 4, the above-described RSSI values may be stored in the sequence of measurement regardless of the number of each ONT 120. Here, the number of each ONT 120 is not significant. However, when the maximum number of ONTs 120 is N, the number of RSSI values that are stored must be N. In this way, the RSSI values are stored in an unused storage space or in the RSSI measurement and storage module 118, in the sequence of measurement. Such a data storage scheme may be implemented in the form of a stack structure. In particular, when N pieces of data are stored, RSSI values are repeatedly stored according to an existing sequence or a new sequence. A repetition period must be N according to the number of ONTs even when the storage of RSSI values is continuously repeated.

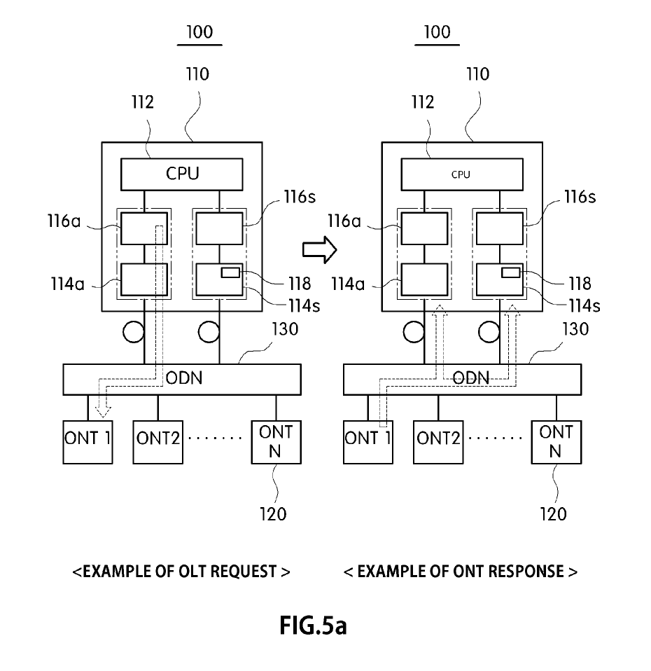

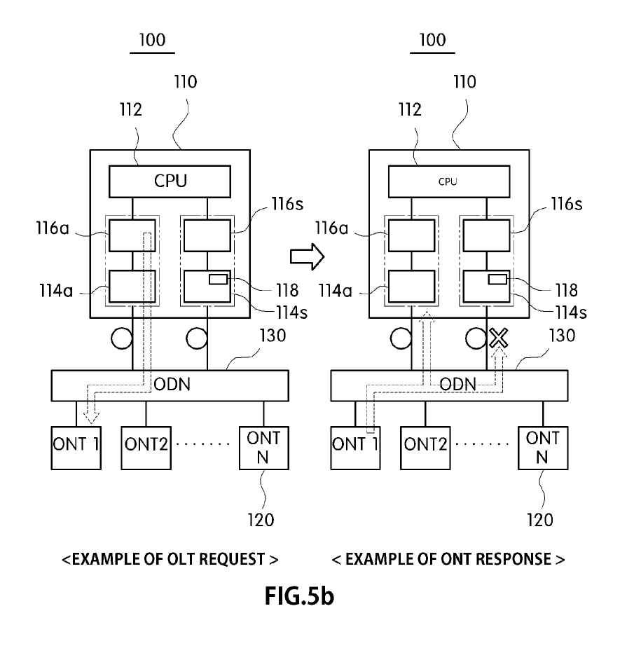

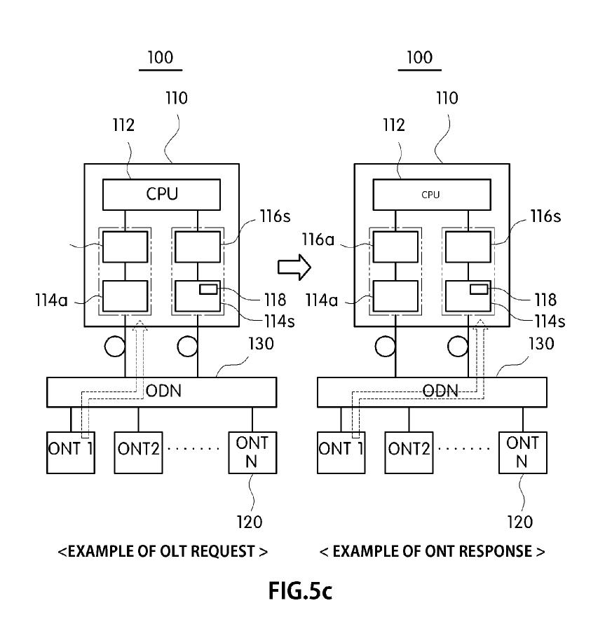

Below, an RSSI measurement and sampling method for determining the stability of a standby line Ls will be described. FIGS. 5A to 5C are configuration diagrams illustrating sampling embodiments of for measuring RSSI to determine the stability of the standby line according to the present invention.

Referring to FIG. 5A, the OLT 110 activates a trigger via the active PON port Pa and the standby line Ls, transmits downstream optical signals to the ONT 120, and receives upstream optical signals from the ONT 120. In this case, the upstream optical signals received from the ONT 120 are automatically distributed through the passive ODN 130, and are then transferred to the active PON port Pa and the standby PON port Ps via the active line La and the standby line Ls, respectively, thus enabling the OLT 110 to monitor the status of the active line La and the standby line Ls.

If a communication failure occurs in the active line La (for example, when an optical fiber is disconnected, received light power is reduced, or an optical wavelength deviates from a set value), the OLT 110 performs the switching of an optical path. For example, the CPU 112 blocks power to be supplied to the optical module 114a in operation, and supplies power to the optical module 114s that is waiting, thus enabling protection switching.

Referring to FIG. 5B, when a communication failure occurs in the standby line Ls due to an event such as the disconnection of an optical fiber, and the reception of light is not fundamentally performed, the standby PON port Ps may immediately provide an alarm to the CPU 112.

Referring to FIG. 5C, when the disconnection of the optical fiber is reported to an operator and the optical fiber is recovered, but RSSI values do not reach a reference value (when the degree of attenuation of received light falls out of an allowable range), a problem arises in that service interruption occurs upon protection switching in spite of recovery.

On the assumption that an RSSI value measured in the active line La is 10 dB and an RSSI value measured in a branch line for connecting the ODN 130 to each ONT 120 is 15 dB, when the RSSI value measured in the standby line Ls increases to a value greater than 15 dB even if the fault in the standby line Ls has been recovered, communication may be occasionally maintained in spite of an increased margin for each subscriber. However, in the case where the ONT 120 is located relatively far away, a communication failure may occur because the degree (range) of attenuation of received light excessively increases above an allowable limit.

In this way, the CPU 112 compares the RSSI value of the active line La with the RSSI value of the standby line Ls. If the difference between the RSSI values is determined to exceed an allowable limit, it is determined that the standby line Ls is instable, and such instability may be reported to the operator.

As described above, in accordance with the configuration of the present invention, the following advantages may be expected.

In a conventional PON system, an RSSI measurement function cannot be performed in a standby PON port, whereas the present invention may determine the stability of a standby line by enabling the measurement of RSSI in the standby PON port, thus effectively realizing protection switching.

Further, even in an existing optical module that does not support an RSSI measurement function, RSSI values may be monitored by merely changing software without changing hardware, thus improving economic efficiency.

As described above, the present invention adopts, as a technical spirit, a scheme in which a standby PON port may measure the RSSI values of a standby line and sample the RSSI values of the standby line in real time before a fault occurs in an active line, and in which, even if protection switching is performed due to the occurrence of a fault in the active line, and a current line is switched from the active line to the standby line, preemptive action is taken so that the RSSI values of the standby line may be maintained in an allowable range of the RSSI values of the active line. Accordingly, those skilled in the art will appreciate that various modifications, additions and substitutions are possible, without departing from the scope and spirit of the invention as disclosed in the accompanying claims.

What is claimed is:

1. A port-dualized Passive Optical Network (PON) system, the system being configured such that trunk lines of an Optical Line Terminal (OLT) and a plurality of Optical Network Terminals (ONTs) are dualized into active lines and standby lines, and such that, when a fault occurs in an active line in use, protection switching of traffic from an active PON port to a standby PON port is performed under control of a Central Processing Unit (CPU), wherein:
the active PON port comprises,
a first optical module for transmitting/receiving an optical signal to/from each ONT through the active line; and
a PON Media Access Control (MAC) chip for applying a trigger signal to the first optical module and then detecting a loss-of-signal (LOS) signal, and
the standby PON port comprises a second optical module for receiving an optical signal to/from the ONT through the standby line, and autonomously detecting a LOS signal in response to a self-trigger signal in compliance with an operation command from the CPU.

2. The port-dualized PON system of claim 1, wherein Received Signal Strength Indicator (RSSI) values are stored in an unused area inside of the second optical module, and the CPU reads the RSSI values from the storage space of the second optical module if necessary.

3. The port-dualized PON system of claim 2, wherein the storage space of the second optical module stores the RSSI values in a form of a stack structure in a sequence of measurement of the ONTs.

4. The port-dualized PON system of claim 3, wherein a number of RSSI values is identical to a number of the ONTs.

5. A port-dualized Optical Line Terminal (OLT), comprising:
an active Passive Optical Network (PON) port for measuring active RSSI values of a first optical module in response to a signal from a PON Media Access Control (MAC) chip;
a standby PON port for allowing a second optical module to autonomously measure and store standby RSSI values; and
a Central Processing Unit (CPU) for activating the active PON port, setting the standby PON port in preparation for occurrence of an event in the active PON port, and determining the active RSSI values and the standby RSSI values, based on a comparison therebetween.

6. The port-dualized OLT of claim 5, wherein the standby RSSI values are configured such that, when a degree of attenuation of the standby RSSI values exceeds an allowable limit compared to that of the active RSSI values, an alarm is provided to an operator.

7. A method of determining stability of a standby line using a port-dualized PON system, comprising:
allowing an optical module of a standby PON port to autonomously measure RSSI values of a standby line in response to a self-trigger signal in compliance with an operation command from a CPU;
storing the standby RSSI values in the optical module;
reading, by the CPU, the stored standby RSSI values, and comparing the standby RSSI values with active RSSI values detected by an active PON port; and
determining, by the CPU, the standby line to be instable if, as a result of the comparison, a degree of attenuation of the standby RSSI values increases above a reference degree.

8. The method of claim 7, wherein the standby RSSI values are randomly stored regardless of each ONT number, and a number of standby RSSI values identical to a number of ONTs are sequentially stored so that the standby RSSI values do not overlap each other.
